(19) United States
(12) Patent Application Publication
(10) Pub. No.: US 2026/0295900 A1
(43) Pub. Date: Oct. 1, 2026

(54) MULTI-LEVEL SEGMENTED MANDREL SYSTEM AND METHOD FOR COMPOSITE SHAPES WITH NEGATIVE DRAFT

(71) Applicant: RTX CORPORATION, Farmington, CT (US)

(72) Inventors: Jonas BANHOS, West Hartford, CT (US); Jonathan E. EHEANDER, Suffield, CT (US); James T. ROACH, Vernon, CT (US); Russell KIM, Temecula, CA (US)

(73) Assignee: RTX CORPORATION, Farmington, CT (US)

(21) Appl. No.: 19/092,318

(22) Filed: Mar. 27, 2025

(51) Int. Cl. B28B 7/30

(52) U.S. Cl. CPC B28B 7/30

(57) ABSTRACT

A mandrel system and method for may be used to produce a closed-end hollow ceramic matrix composite (CMC) part with a negative draft, with the CMC part having a proximal open end and a distal closed end. The system includes a first layer of mandrel configured for a first portion of the CMC part and having a first distal surface adjacent the closed-end of the CMC part, the first layer being formed of a first plurality of segments. The system also includes a second layer of mandrel configured for a second portion of the CMC part and having a second distal surface adjacent a proximal surface of the first layer, the second layer being formed of a second plurality of segments. The first and second plurality of segments are configured to be extractable from the proximal open end of the CMC part.

### FIELD OF THE INVENTION

The subject matter disclosed herein relates to mandrels used to produce composites such as Ceramic Matrix Composites (CMCs) and, in particular, to multi-level segmented mandrels used to produce closed-end hollow CMC parts that have a negative draft.

### BACKGROUND OF THE INVENTION

Gas turbine engines or jet engines, in general, include a fan section, a compressor section, a combustion section, and a turbine section. Air enters through the fan section and is compressed in the compressor section before being introduced into the combustion section. In the combustion section, the air is mixed with fuel and ignited to generate a high-energy, high temperature gas flow. The high-energy, high temperature gas flow is expanded in the turbine section which is used to create thrust and to drive the compressor and fan sections.

Certain components of gas turbine engines are thus exposed to the high-energy, high temperature gas flow (i.e., gaspath components). Therefore, it is desirable that such components be made of heat-resistant materials such as ceramic matrix composites (CMCs), which can withstand much higher operating temperatures than components composed of metal superalloys. Silicon Carbide (SiC) based CMCs fabricated via Chemical Vapor Infiltration (CVI), Melt Infiltration (MI), Polymer Infiltration and Pyrolysis (PIP), and hybrids of CVI/MI and CVI/PIP possess such high temperature capability. Such CMC components are typically fabricated from a near-net shape fiber preform, typically formed from fabric and tow layups.

Many CMC components may be fabricated using a layup procedure wherein a fabric layup is wrapped or otherwise surrounds a mandrel that provides a rigid surface for forming the part. For example, CMC parts may be built with a CMC fabric via a layup procedure wherein the layup surrounds an appropriately-shaped mandrel to provide a rigid surface prior to the first stages of densification (via CVI, MI, PIP and hybrids thereof).

For CMC parts such as airfoils and combustor bulk-heads that have cavities, it is desirable to use a mandrel to form such cavities. However, airfoil shapes are dictated by aerodynamic requirements that often require twisted and/or curved shapes that taper to have a negative draft and combustor bulk-heads may be a one-side closed part with a negative draft. For metal airfoils and combustors, casting and other techniques may be used to form twisted and/or curved parts with closed end and a negative draft. However, twisted and/or curved parts as well as other parts with a closed end and a negative draft formed on a mandrel may make it impossible to extract the mandrel.

One solution to the mandrel extraction problem is the use of a mandrel materials that are substantially absorbed during thermal treatment of a preform to form the CMC part, as disclosed in U.S. Pat. No. 10,450,235 to Gray et al. However, in some cases, the fugitive material may interfere with the development of the CMC part during a chemical vapor deposition/infiltration process, increasing densification time and/or effectively contaminating the desired material of the CMC part. Additionally, as such mandrels are not reusable, this solution may involve waste and increased cost.

The above information disclosed in this Background section is only for understanding of the background of the inventive concepts and, therefore, it may contain information that does not constitute prior art.

### SUMMARY OF THE INVENTION

The present disclosure is directed, in a first aspect, to a mandrel system for producing a closed-end hollow ceramic matrix composite (CMC) part with a negative draft, with the CMC part having a proximal open end and a distal closed end. The mandrel system includes: a first layer of mandrel configured for a first portion of the CMC part and having a first distal surface adjacent the closed end of the CMC part, the first layer formed of a first plurality of segments; and a second layer of mandrel configured for a second portion of the CMC part and having a second distal surface adjacent a proximal surface of the first layer, the second layer formed of a second plurality of segments. In the mandrel system, the second plurality of segments are configured to be extractable from the proximal open end of the CMC part and the first plurality of segments are configured to be extractable from the proximal open end of the CMC part after the second plurality of segments have been extracted.

In an embodiment of the system, each of the first plurality of segments and the second plurality of segments may include a central cylindrical segment, two positive draft segments that each have contact surfaces with the central cylindrical segment along less than half of a cylindrical surface of the central cylindrical segment, and a plurality of remaining segments including at least two positive draft segments.

In another embodiment of the system, each of the central cylindrical segments may include grooves in a cylindrical surface thereof and an angled hole in a proximal surface thereof.

In a further embodiment of the system, each of the first plurality of segments and the second plurality of segments may include an extraction sequence.

In yet another embodiment of the system, a first periphery of the proximal surface of the first layer may include a first alignment surface and a second periphery of the distal surface of the second layer may include a second alignment surface configured to mate with the first alignment surface.

In an embodiment of the system, the first alignment surface may be a chamfered recess and the second alignment surface may be a corresponding protrusion.

In another embodiment of the system, each of the two positive draft segments may include surfaces adjacent to a respective one of the central cylindrical segments and surfaces of a respective pair of the remaining segments.

In a further embodiment of the system, proximal edges between the remaining segments may be chamfered.

In yet another embodiment of the system, a plurality of surfaces between respective segments of the first plurality of segments and/or the second plurality of segments may include grooves to reduce a contact area therebetween.

In an embodiment, the system may include a third layer of mandrel configured for a third portion of the CMC part having a third distal surface adjacent a proximal surface of the second layer, the third layer formed of a third plurality of segments, wherein the third plurality of segments may include a central cylindrical segment, two positive draft segments that each have contact surfaces with the central cylindrical segment along less than half of a cylindrical surface of the central cylindrical segment, and a plurality of remaining segments including at least two positive draft segments.

The present disclosure is also directed, in a second aspect, to a method producing a closed-end hollow ceramic matrix composite (CMC) part with a negative draft on a mandrel formed of layers, with the CMC part having a proximal open end and a distal closed end. The method includes: forming a first layer of the mandrel with a first plurality of segments, the first layer configured for a first portion of the CMC part and having a first distal surface adjacent the closed end of the CMC part to be formed thereon; forming a second layer of the mandrel with a second plurality of segments, the second layer configured for a second portion of the CMC part and having a second distal surface adjacent a proximal surface of the first layer; forming a preform of the CMC part on the mandrel; densifying the preform to form the CMC part; extracting the second plurality of segments from the proximal open end of the CMC part; and extracting the first plurality of segments from the proximal open end of the CMC part after the second plurality of segments have been extracted.

In an embodiment of the method, forming the first layer and forming the second layer with each of the first plurality of segments and the second plurality of segments, respectively, may include a central cylindrical segment, two positive draft segments that each have contact surfaces with the central cylindrical segment along less than half of a cylindrical surface of the central cylindrical segment, and a plurality of remaining segments including at least two positive draft segments.

In another embodiment of the method, extracting the first plurality of segments may include a specific sequence of removing the central cylindrical segment, removing the two positive draft segments, and removing the remaining segments.

In a further embodiment of the method, extracting each of the second plurality of segments and the first plurality of segments may include a specific extraction sequence.

In yet another embodiment of the method, forming the first and second layers may further include aligning a first alignment surface on a first periphery of the proximal surface of the first layer with a second alignment surface on a second periphery of the distal surface of the second layer.

In an embodiment of the method, the first alignment surface may be a chamfered recess and the second alignment surface may be a corresponding protrusion.

In another embodiment of the method, forming the first and second layers may further include each of the two positive draft segments having surfaces adjacent to a respective one of the central cylindrical segments and surfaces of a respective pair of the remaining segments.

In a further embodiment of the method, forming the first and second layers may further include chamfering proximal edges between the remaining segments.

In yet another embodiment of the method, forming the first and second layers may further include providing grooves in a plurality of surfaces between respective segments of the first plurality of segments and/or the second plurality of segments to reduce a contact area therebetween.

The present disclosure is further directed, in a third aspect, to a method of forming a layer of a multi-layer mandrel for a ceramic matrix composite (CMC) part. The method includes: forming a graphite core having a shape of the layer of the multi-layer mandrel; cutting a circular shape in the graphite core transverse a plane of the layer to form a central cylindrical segment; making two converging cuts substantially tangent to the circular shape to form a first positive draft segment; making two converging cuts substantially tangent to the circular shape to form a second positive draft segment; making a first cut substantially normal to the circular shape to form two remaining segments, at least one of which is a positive draft segment; and making a second cut substantially normal to the circular shape to form an additional two remaining segments, at least one of which is a positive draft segment.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1A is a first perspective view of an example of a generic hollow composite part in accordance with the present disclosure;

FIG. 1B is a top view of the example generic hollow composite part in accordance with the present disclosure;

FIG. 1C is a side elevation view of the example generic hollow composite part in accordance with the present disclosure;

FIG. 1D is an end elevation view of the example generic hollow composite part in accordance with the present disclosure;

FIG. 2A is a second perspective view of the hollow composite part (or fabric layup) covering a mandrel in accordance with the present disclosure;

FIG. 2B is a perspective view of the mandrel used in FIG. 2A in accordance with the present disclosure;

FIG. 2C is a perspective view of the mandrel of FIG. 2B with an exploded view of one of the layers in accordance with the present disclosure;

FIG. 3 is a top view of a sequence of an example of a layer of mandrel being extracted in accordance with the present disclosure;

FIGS. 4A and 4B are perspective views of an example layer of a mandrel that has segments with chamfered edges in accordance with the present disclosure;

FIGS. 5A, 5B, and 5C are top, side, and end perspective views of an example of chamfered mandrel segments aiding in segment extraction in accordance with the present disclosure;

FIG. 6A is a perspective view of a first layer of a mandrel having a peripheral locating surface in accordance with the present disclosure;

FIG. 6B is a perspective view of a first layer and a second layer of a mandrel with an example of mating peripheral locating surfaces in accordance with the present disclosure;

FIG. 6C is a perspective view of the first layer and the second layer of FIG. 6B in a mating position in accordance with the present disclosure;

FIG. 7 is a perspective view of various example layer segments having grooves on segment contact surfaces in accordance with the present disclosure;

FIG. 8A is a top view of an example of an extraction tool operating on an angled hole in a proximal surface of a central cylindrical segment in accordance with the present disclosure;

FIG. 8B is a side view of the example of an extraction tool operating on an angled hole in a proximal surface of a central cylindrical segment in accordance with the present disclosure;

FIG. 8C is a top view of example of an extraction tool operating on an angled hole in a proximal surface of a central cylindrical segment in accordance with the present disclosure;

FIG. 9A is a top view of an example layer core with example cut lines illustrated in accordance with the present disclosure;

FIG. 9B is an upper perspective view of the cut layer core of FIG. 9A in accordance with the present disclosure;

FIG. 9C is a bottom perspective view of the cut layer core of FIG. 9A in accordance with the present disclosure;

FIG. 10 is an example cross section of a mandrel system having three layers in accordance with the present disclosure;

FIG. 11 is a flow diagram of an example process of forming a hollow composite part in accordance with the present disclosure; and

FIG. 12 is a flow diagram of an example process of forming and segmenting a layer of mandrel in accordance with the present disclosure.

### DETAILED DESCRIPTION OF THE INVENTION

The embodiments of the present disclosure can comprise, consist of, and consist essentially of the features and/or steps described herein, as well as any of the additional or optional elements, components, steps, or limitations described herein or would otherwise be appreciated by one of skill in the art.

The following discussion omits or only briefly describes conventional features of the disclosed technology that are apparent to those skilled in the art. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to use the instant invention, in combination with routine experiments, to achieve other outcomes not specifically disclosed in the examples or the embodiments.

Unless otherwise specifically defined herein, all terms are to be given their broadest possible interpretation including meanings implied from the specification as well as meanings understood by those skilled in the art and/or as defined in dictionaries, treatises, etc. Unless defined otherwise, all technical and scientific terms used herein have the same meaning as commonly understood by one of ordinary skill in the art in the field of the disclosed technology. It must also be noted that, as used in the specification and the appended claims, the singular forms “a,” “an,” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. Additionally, methods, equipment, and materials similar or equivalent to those described herein can also be used in the practice or testing of the disclosed technology.

The devices of the present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. All spatial references, such as, for example, proximal, distal, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior.”

It will further be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

Various examples of the disclosed technology are provided throughout this disclosure. The use of these examples is illustrative only, and in no way limits the scope and meaning of the invention or of any exemplified form. Likewise, the invention is not limited to any particular preferred embodiments described herein. Indeed, modifications and variations of the invention may be apparent to those skilled in the art upon reading this specification, and can be made without departing from its spirit and scope. The invention is therefore to be limited only by the terms of the claims, along with the full scope of equivalents to which the claims are entitled.

The present disclosure is directed to systems and methods for producing a closed-end hollow ceramic matrix composite (CMC) part with a negative draft, with the CMC part having a proximal open end and a distal closed end. The system includes a first layer of mandrel configured for a first portion of the CMC part and having a first distal surface adjacent the closed-end of the CMC part, the first layer being formed of a first plurality of segments. The system also includes a second layer of mandrel configured for a second portion of the CMC part and having a second distal surface adjacent a proximal surface of the first layer, the second layer being formed of a second plurality of segments. The first and second plurality of segments are configured to be extractable from the proximal open end of the CMC part.

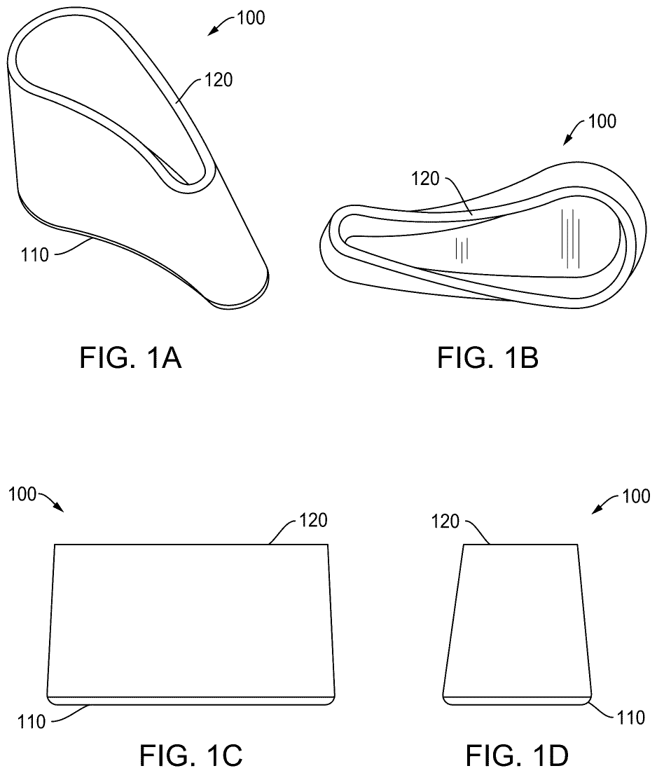

Referring to FIGS. 1A, 1B, 1C, and 1D, a generic ceramic matrix composite (CMC) part and/or its fabric layup (hereinafter alternately referred to as “part” or “preform” since they both refer to the same elements at various times during production) 100, such as for a hollow CMC airfoil or combustor bulkhead, may be twisted and/or curved and narrows from a distal closed end 110 to a proximal open end 120. Because of this narrowing, the mandrel for the CMC part may be considered to have a negative draft for purposes of mandrel extraction.

As used herein, positions may be considered from a location where a mandrel or segment thereof may be extracted. Accordingly, positions relatively closer to the open end 120 may be referred to herein as “proximate” and positions relatively closer to the closed end may be referred to herein as “distal.” In some instances, the proximate end will be considered the “top” and the distal end will be considered the “bottom” for the description of various views.

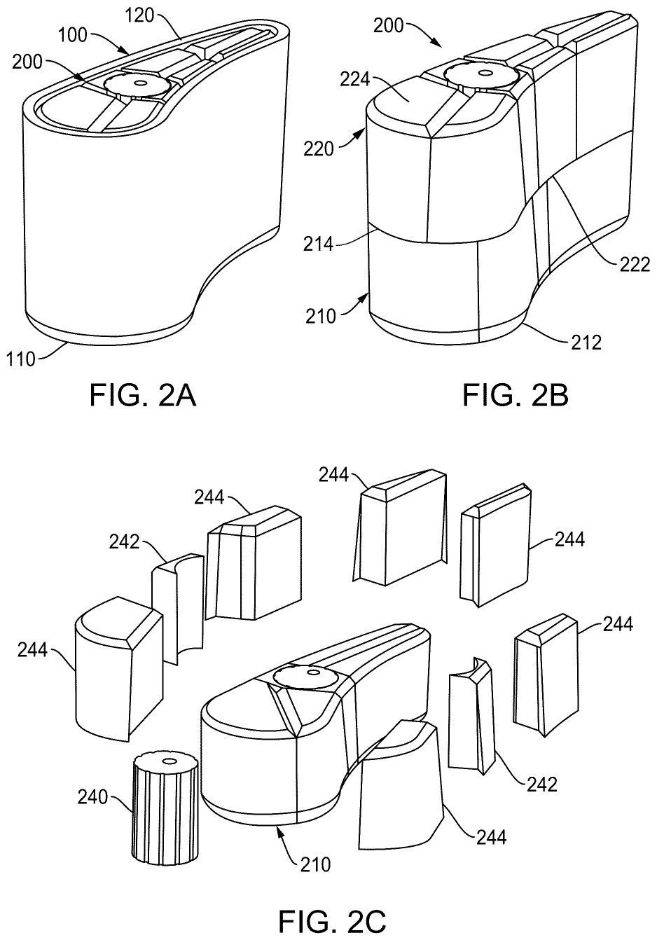

Referring to FIG. 2A, a second perspective view of the hollow composite part (or fabric layup) 100 is illustrated covering a mandrel 200 in accordance with the present disclosure. Additional detail is shown in FIG. 2B which is a perspective view of the mandrel 200 used in FIG. 2A in accordance with the present disclosure. FIG. 2C is a perspective view of the mandrel of FIG. 2B with an exploded view of one of the layers 220.

FIGS. 2A, 2B, and 2C relate to mandrel system or mandrel 200 for producing the closed-end hollow CMC part 100 with a negative draft, the CMC part 100 having a proximal open end 120 and a distal closed end 110.

A first layer 210 of mandrel 200 is configured for a first portion of the CMC part 100. The first layer 210 has a first distal surface 212 adjacent the closed end 110 of the CMC part 100. As shown in FIGS. 2B and 2C, the first layer formed of a first plurality of segments 240, 242, and 244.

A second layer 220 of mandrel 200 is configured for a second portion of the CMC part 100. The second layer 220 may be stacked on the first layer 210 as shown in FIG. 2B. The second layer 220 has a second distal surface 222 opposing a first proximal surface 214 of the first layer 210 and a second proximal surface 224. The second layer 220 is also formed of a second plurality of segments 240, 242, and 244.

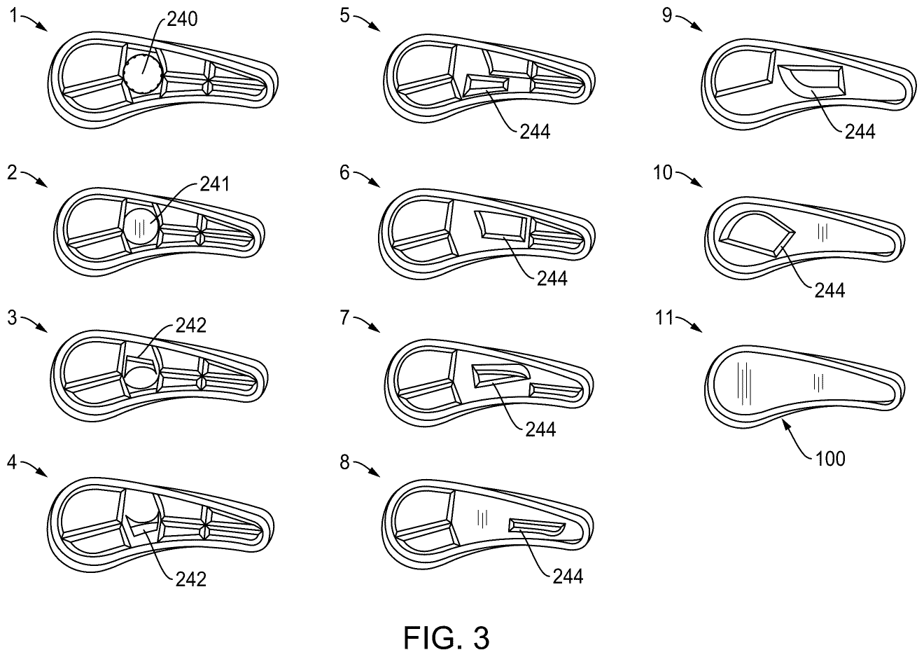

As will be explained in further detail with respect to FIG. 3, the second plurality of segments 240, 242, and 244 are configured to be extractable from the proximal open end 120 of the CMC part 100, and the first plurality of segments 240, 242, and 244 are also configured to be extractable from the proximal open end 120 of the CMC part 100 after the second plurality of segments 240, 242, and 244 have been extracted.

With respect to FIG. 2C, the first plurality of segments of layer 210 and the second plurality of segments of layer 220 of the mandrel 200 may include a central cylindrical segment 240, two positive draft segments 242 that each have contact surfaces with the central cylindrical segment 240 along less than half of a cylindrical surface of the central cylindrical segment 240, and a plurality of remaining segments 240 that include at least two positive draft segments. The combination of central cylindrical segment 240, the two positive draft segments 242, and the remaining segments 240 that include at least two positive draft segments allows each layer 210, 220 to be extracted despite the negative draft of the CMC part 100.

FIG. 3 is a top view of an example sequence of a layer such as layer 220 of mandrel 200 being extracted in accordance with the present disclosure.

In an initial state (1), all segments are in place and central cylindrical segment 240 is selected for removal, which can be done by rotating to loosen it from other segments and vertical extraction due to the 0 draft of a cylinder. At state (2), the central cylindrical segment is removed, leaving an open space 241.

In state (3), a first of the two positive draft segments 242 is moved into space 241 to permit removal, and in state (4), a second of the two positive draft segments 242 is moved into space 241 to permit removal.

States (5)-(10) involve removal of the remaining segments 244, and for each adjacent pair of remaining segments 244, at least one of the segments has a positive draft such that its extraction frees up sufficient space for the other segment of the pair to be extracted. For example, in state (5), a first remaining segment 244 with a positive draft is moved into the open space for removal, and in state (6), a second remaining segment 244 that may or may not have a positive draft has sufficient space to be extracted. In one or more embodiments, each of the two positive draft segments 242 may include surfaces adjacent to the central cylindrical segment 240 and surfaces of a respective pair of the remaining segments 244.

In a case where additional remaining segments 244 are disposed behind those removed at states (5) and (6), such as in layer 220, those additional segments may be removed. For example, in state (7), a first remaining segment 244 with a positive draft is moved into the open space for removal, and in state (8), a second remaining segment 244 that may or may not have a positive draft has sufficient space to be extracted. If no such additional segments are present, such as in layer 210, the sequence can skip to state (9).

Continuing the extraction sequence, in state (9), a first remaining segment 244 with a positive draft is moved into the open space for removal, and in state (10), a second remaining segment 244 that may or may not have a positive draft has sufficient space to be extracted, resulting in state (11) wherein an entire layer 220 (or 210) of the mandrel 200 is removed from CMC part 100. Thus, in one or more embodiments, each of the first plurality of segments and the second plurality of segments may include an extraction sequence.

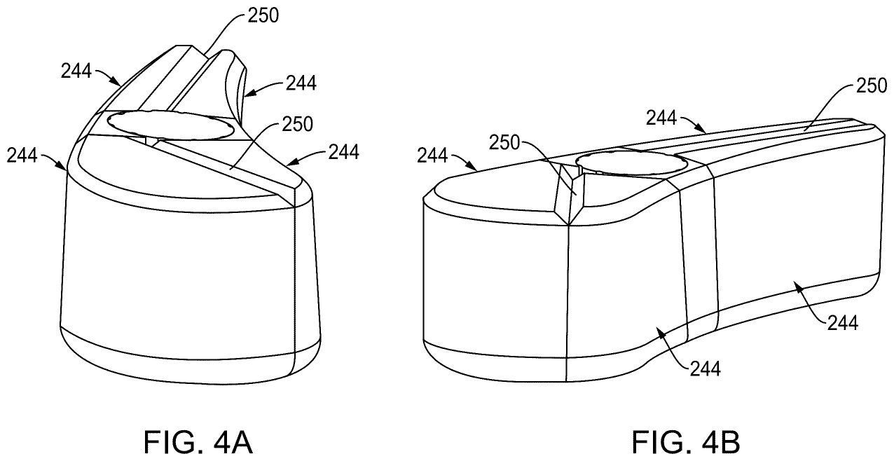

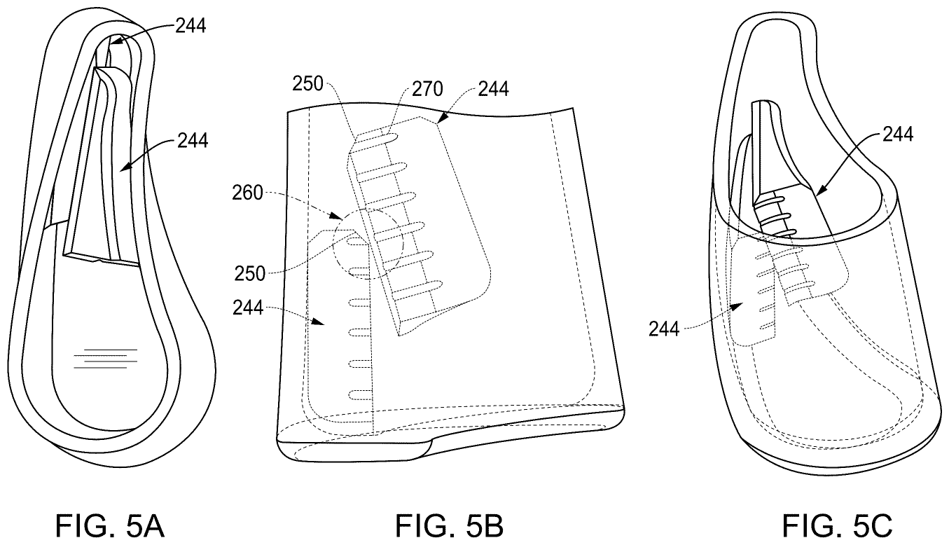

FIGS. 4A and 4B are perspective views of an example layer such as layer 210 of a mandrel 200 that has segments with chamfered edges in accordance with the present disclosure. FIGS. 5A, 5B, and 5C are top, side, and end perspective views of an example of chamfered mandrel segments aiding in segment extraction in accordance with the present disclosure.

As illustrated in FIGS. 4A and 4B, a first layer 210 of mandrel 200 may include proximal edges 250 between the remaining segments 244 that are chamfered. Such chamfered edges 250 may permit an adjacent segment 244 to tilt or be angled into the area 260 freed up by the chamfered edge 250, as illustrated in the views of FIGS. 5A, 5B, and 5C.

Further, as illustrated in FIG. 5B, the surfaces of remaining segments 244 that contact central cylindrical segment 240 (not shown) may include grooves 270 or the like to decrease a contact area so as to permit easier extraction of central cylindrical segment 240.

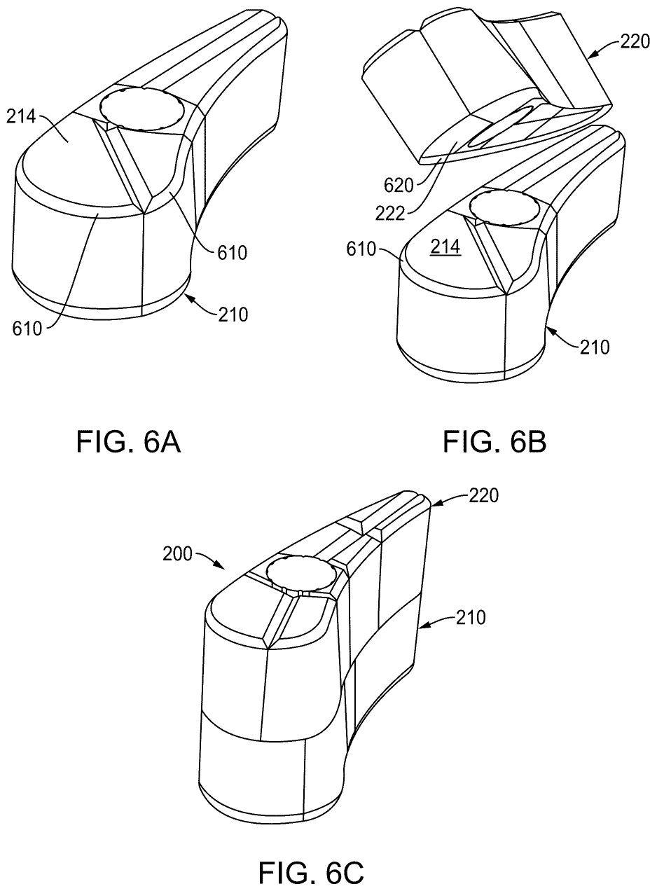

With regard to FIG. 6A and FIG. 6B, a perspective view is illustrated of a first layer 210 of a mandrel 200 that includes a peripheral locating surface in accordance with the present disclosure. Specifically, a first periphery of the proximal surface 214 of the first layer 210 includes a first alignment surface 610. As illustrated in FIG. 6B, a second layer 220 of a mandrel 200 may include a second mating peripheral locating surfaces in accordance with the present disclosure. Specifically, a second periphery of the distal surface 222 of the second layer 220 may include a second alignment surface 620 configured to mate with the first alignment surface 610. In one or more embodiments, the first alignment surface 610 may be a chamfered recess and the second alignment surface 620 may be a corresponding protrusion. The peripheral locating surfaces of the first alignment surface 610 on first layer 210 and the second alignment surface 620 of second layer 220 mate with each other so as to allow the first and second layers 210 and 220 to be stacked and aligned to form mandrel 200, as shown in FIG. 6C.

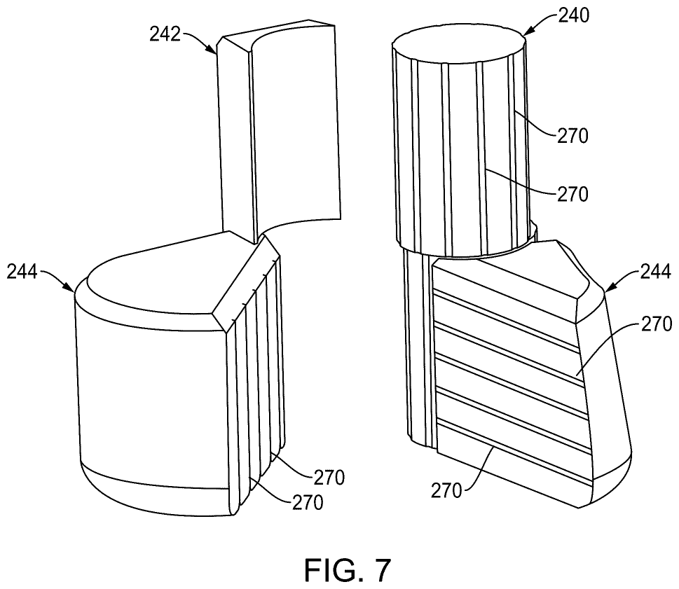

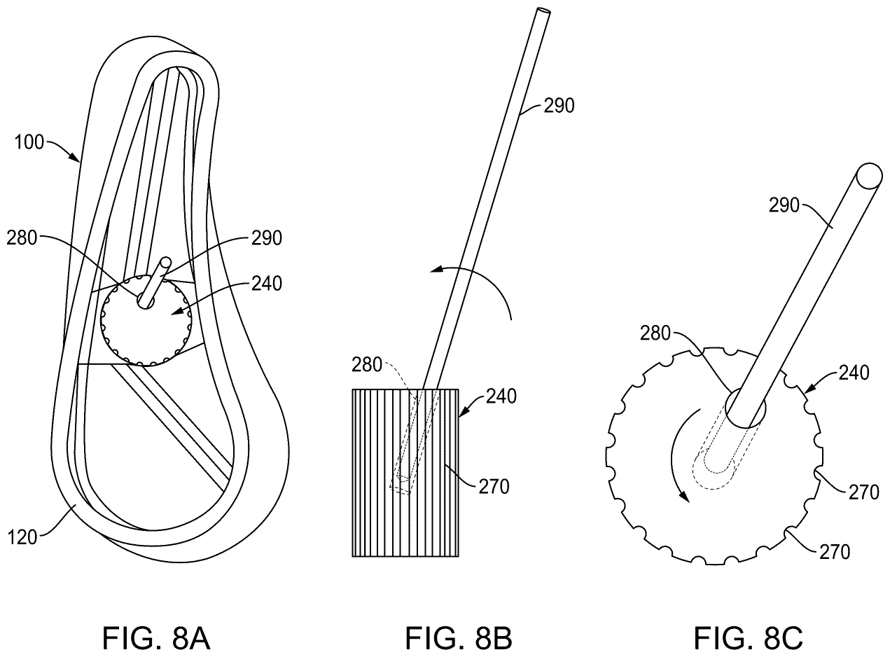

FIG. 7 illustrates a perspective view of various example layer segments having grooves 270 disposed on segment contact surfaces in accordance with the present disclosure. In the illustrated example, central cylindrical segment 240 may have vertical grooves 270 and remaining segments 244 have vertical and horizontal grooves 270 that are transverse to each other. In use, the various grooves 270 may reduce a contact area between the various segments in order to allow easier separation for extraction after a densification process. Indeed, during densification (heating, SiC infiltration, etc.), various segments making up mandrel 200, despite being formed of graphite for example, may adhere to each other and require application of some force to separate. Indeed, segments may include structures for allowing application of force. Thus, one or more embodiments in accordance with the present disclosure may include grooves on a plurality of surfaces between respective segments of the first plurality of segments and/or the second plurality of segments to reduce a contact area therebetween.

FIGS. 8A, 8B, and 8C illustrate one embodiment of such a structure for applying force to the central cylindrical segment 240. Although disclosed with respect to the central cylindrical segment 240, other segments 242 and/or 244 may also include similar structures to facilitate separation and extraction.

FIG. 8A is a top view of an example of an extraction tool 290 operating on an angled hole 280 in a proximal surface of a central cylindrical segment 240 in accordance with the present disclosure. Hole 280 may be angled to permit extraction tool 290, a metal bar in this example, to extend through the proximal open end 120 of the CMC part 100.

FIG. 8B is a side view of the example of an extraction tool 290 operating on the angled hole 280 in a proximal surface of a central cylindrical segment 240 in accordance with the present disclosure. Extraction tool 290, in addition to being long enough to extend through proximal open end 120, may have a length sufficient to provide torque to rotate the central cylindrical segment 240 and break any adhesion with adjacent segments. FIG. 8C is a top view of the extraction tool 290 operating on an angled hole 280 in a proximal surface of a central cylindrical segment 240 in accordance with the present disclosure when used to provide the torque, shown with the arrow. As further shown in FIG. 8C, grooves 270 on central cylindrical segment 240 may reduce its contact surface and reduce possible adhesion forces.

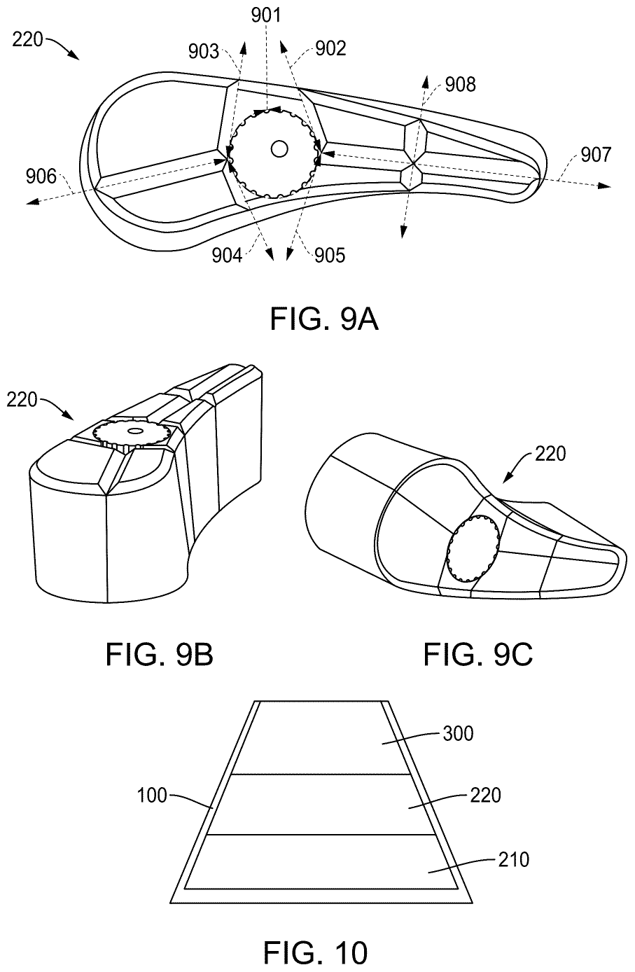

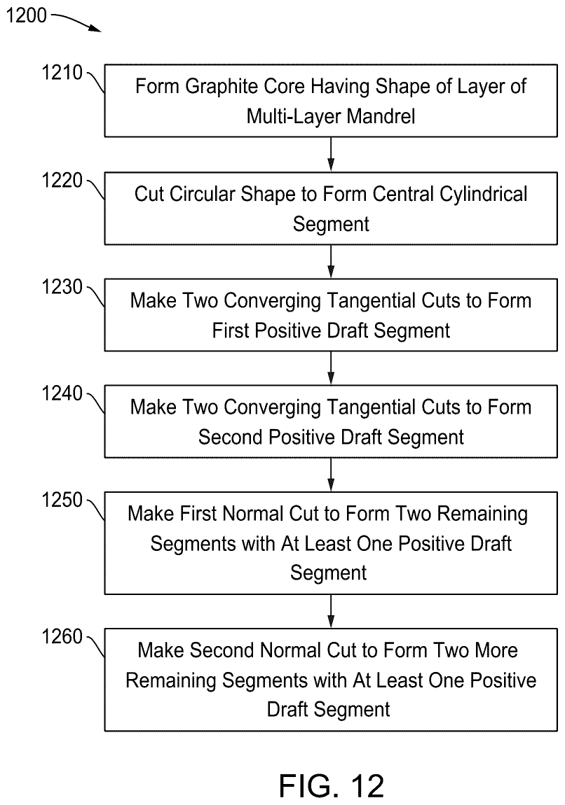

FIG. 9A is a top view of an example layer core to be used to form, for example, second layer 220 of the mandrel 100. FIG. 9A shows example cut lines illustrated in accordance with an embodiment of the present disclosure, FIG. 9B is an upper perspective view of the cut layer core of FIG. 9A, and FIG. 9C is a bottom perspective view of the cut layer core of FIG. 9A. As discussed further below with respect to FIG. 12, the core may be a graphite core having a shape of the layer, in this case second layer 220, of the multi-layer mandrel 100.

A first cut 901 may be a circular shape in the graphite core transverse a plane of the layer 220 to form a central cylindrical segment. Two converging cuts 902 and 903 may be made substantially tangent to the circular shape to form a first positive draft segment. Another two converging cuts 904 and 905 may be made substantially tangent to the circular shape to form a second positive draft segment. Then, a first cut 906 may be made substantially normal to the circular shape to form two remaining segments, at least one of which is a positive draft segment. A second cut 907 may be made substantially normal to the circular shape to form an additional two remaining segments, at least one of which is a positive draft segment. While not needed for the example first layer (see, e.g., first layer 210 of FIG. 2C), for second layer 220 as disclosed herein, a cut 908 may be made substantially transverse to cut 907 to form an additional two remaining segments, at least one of which is a positive draft segment.

While the mandrel embodiments discussed heretofore include first and second layers 210 and 220, respectively, embodiments in accordance with the present disclosure are not limited thereto and may include additional layers. For example, FIG. 10 is an example cross section of a mandrel system having three layers-a first layer 210, a second layer 220, and a third layer 300. As with the previously described embodiments, the third layer 300 may include a plurality of segments (i.e., a third plurality of segments that include a central cylindrical segment, two positive draft segments that each have contact surfaces with the central cylindrical segment along less than half of a cylindrical surface of the central cylindrical segment, and a plurality of remaining segments including at least two positive draft segments), a peripheral alignment surface, grooves, an extraction sequence, etc.

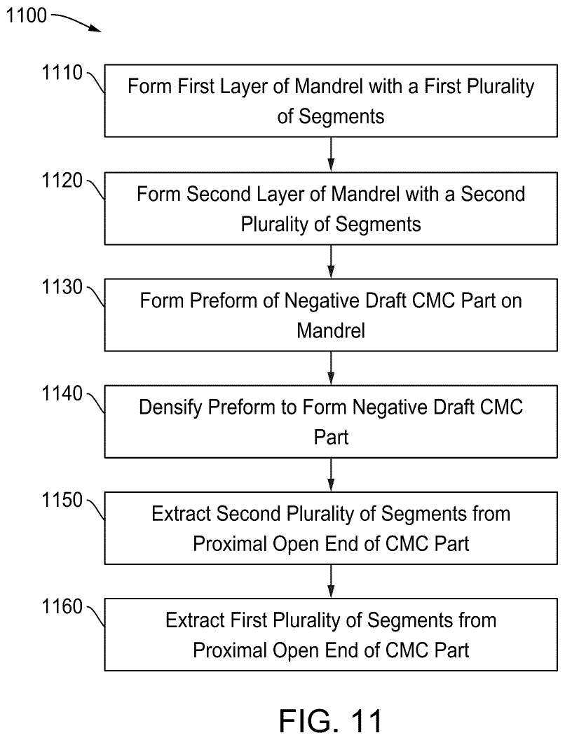

FIG. 11 is a flow diagram of an example method 1100 of forming a hollow composite part in accordance with the present disclosure.

Method 1100 relates to producing a closed-end hollow CMC part with a negative draft on a mandrel formed of layers, the CMC part having a proximal open end and a distal closed end. Method 1100 includes a step 1110 of forming a first layer of the mandrel with a first plurality of segments, the first layer configured for a first portion of the CMC part and having a first distal surface adjacent the closed-end of the CMC part to be formed thereon.

Method 1100 also includes a step 1120 of forming a second layer of the mandrel with a second plurality of segments, the second layer configured for a second portion of the CMC part and having a second distal surface adjacent a proximal surface of the first layer.

Next is step 1130 of forming a preform of the CMC part on the mandrel, and a step 1140 of densifying the preform to form the CMC part.

After the densification of step 1140, the mandrel may be extracted. Step 1150 includes extracting the second plurality of segments from the proximal open end of the CMC part, and step 1160 includes extracting the first plurality of segments from the proximal open end of the CMC part after the second plurality of segments have been extracted.

In various embodiments, the steps 1110 and 1120 of forming the first layer and forming the second layer with each of the first plurality of segments and the second plurality of segments, respectively, may include forming a central cylindrical segment, two positive draft segments that each have contact surfaces with the central cylindrical segment along less than half of a cylindrical surface of the central cylindrical segment, and a plurality of remaining segments including at least two positive draft segments.

In another embodiment, the step 1150 of extracting each of the second plurality of segments and the first plurality of segments includes a specific extraction sequence.

In an embodiment, the step 1160 of extracting the first plurality of segments includes a specific sequence of removing the central cylindrical segment, removing the two positive draft segments, and removing the remaining segments.

In various embodiments, the steps 1110 and 1120 of forming the first and second layers may further include aligning a first alignment surface on a first periphery of the proximal surface of the first layer with a second alignment surface on a second periphery of the distal surface of the second layer. In various embodiments, the first alignment surface may be a chamfered recess and the second alignment surface may be a corresponding protrusion.

In some embodiments, the steps 1110 and 1120 of forming the first and second layers may further include each of the two positive draft segments having surfaces adjacent to a respective one of the central cylindrical segments and surfaces of a respective pair of the remaining segments.

In other embodiments, the steps 1110 and 1120 of forming the first and second layers may further include chamfering proximal edges between the remaining segments.

In further embodiments, the steps 1110 and 1120 of forming the first and second layers may further include providing grooves in a plurality of surfaces between respective segments of the first plurality of segments and/or the second plurality of segments to reduce a contact area therebetween.

FIG. 12 is a flow diagram of an example method 1200 of forming and segmenting a layer of mandrel in accordance with the present disclosure.

The method 1200 involves forming a layer of a multi-layer mandrel for a CMC part. A first step 1210 of method 1200 includes forming a graphite core having a shape of the layer of the multi-layer mandrel. In a next step 1220, a circular shape is cut in the graphite core transverse to a plane of the layer to form a central cylindrical segment.

Step 1230 of method 1200 includes making two converging cuts substantially tangent to the circular shape to form a first positive draft segment. Similarly, step 1240 of method 1200 includes making another two converging cuts substantially tangent to the circular shape to form a second positive draft segment. In one or more embodiments, these converging cuts may be made

Method 1200 continues with step 1250 of making a first cut substantially normal to the circular shape to form two remaining segments, at least one of which is a positive draft segment; and step 1260 of making a second cut substantially normal to the circular shape to form an additional two remaining segments, at least one of which is a positive draft segment.

In various embodiments, another cut may be made transverse to one of the cuts from steps 1250 and/or 1260 to form an additional two remaining segments, at least one of which is a positive draft segment.

In one or more embodiments, the graphite core may be cut using any suitable technique, such as, but not limited to, wire electrical discharge machining (EDM)

In various embodiments, adhesives or tackifiers may be used to hold the segments together when assembling the various layers of the mandrel.

Embodiments in accordance with the present disclosure may be used to produce CMC parts with very twisted/curved designs that may enable stringent aerodynamic requirements and closed-end hollow CMC parts with a negative draft. The present disclosure permits use of segments that can be better managed during the extraction process as the segments may be individually removed.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A mandrel system for producing a closed-end hollow ceramic matrix composite (CMC) part with a negative draft, the CMC part having a proximal open end and a distal closed end, comprising:
a first layer of mandrel configured for a first portion of the CMC part and having a first distal surface adjacent the closed end of the CMC part, the first layer formed of a first plurality of segments; and
a second layer of mandrel configured for a second portion of the CMC part and having a second distal surface adjacent a proximal surface of the first layer, the second layer formed of a second plurality of segments,
wherein the second plurality of segments are configured to be extractable from the proximal open end of the CMC part and the first plurality of segments are configured to be extractable from the proximal open end of the CMC part after the second plurality of segments have been extracted.

2. The mandrel system of claim 1, wherein each of the first plurality of segments and the second plurality of segments includes a central cylindrical segment, two positive draft segments that each have contact surfaces with the central cylindrical segment along less than half of a cylindrical surface of the central cylindrical segment, and a plurality of remaining segments including at least two positive draft segments.

3. The mandrel system of claim 2, wherein each of the central cylindrical segments includes grooves in a cylindrical surface thereof and an angled hole in a proximal surface thereof.

4. The mandrel system of claim 2, wherein each of the first plurality of segments and the second plurality of segments includes an extraction sequence.

5. The mandrel system of claim 2, wherein a first periphery of the proximal surface of the first layer includes a first alignment surface and a second periphery of the distal surface of the second layer includes a second alignment surface configured to mate with the first alignment surface.

6. The mandrel system of claim 5, wherein the first alignment surface is a chamfered recess and the second alignment surface is a corresponding protrusion.

7. The mandrel system of claim 2, wherein each of the two positive draft segments includes surfaces adjacent to a respective one of the central cylindrical segments and surfaces of a respective pair of the remaining segments.

8. The mandrel system of claim 7, wherein proximal edges between the remaining segments are chamfered.

9. The mandrel system of claim 7, wherein a plurality of surfaces between respective segments of the first plurality of segments and/or the second plurality of segments include grooves to reduce a contact area therebetween.

10. The mandrel system of claim 2, further comprising a third layer of mandrel configured for a third portion of the CMC part having a third distal surface adjacent a proximal surface of the second layer, the third layer formed of a third plurality of segments,
wherein the third plurality of segments includes a central cylindrical segment, two positive draft segments that each have contact surfaces with the central cylindrical segment along less than half of a cylindrical surface of the central cylindrical segment, and a plurality of remaining segments including at least two positive draft segments.

11. A method producing a closed-end hollow ceramic matrix composite (CMC) part with a negative draft on a mandrel formed of layers, the CMC part having a proximal open end and a distal closed end, comprising:
forming a first layer of the mandrel with a first plurality of segments, the first layer configured for a first portion of the CMC part and having a first distal surface adjacent the closed end of the CMC part to be formed thereon;
forming a second layer of the mandrel with a second plurality of segments, the second layer configured for a second portion of the CMC part and having a second distal surface adjacent a proximal surface of the first layer;
forming a preform of the CMC part on the mandrel;
densifying the preform to form the CMC part;
extracting the second plurality of segments from the proximal open end of the CMC part; and
extracting the first plurality of segments from the proximal open end of the CMC part after the second plurality of segments have been extracted.

12. The method of claim 11, wherein forming the first layer and forming the second layer with each of the first plurality of segments and the second plurality of segments, respectively, includes a central cylindrical segment, two positive draft segments that each have contact surfaces with the central cylindrical segment along less than half of a cylindrical surface of the central cylindrical segment, and a plurality of remaining segments including at least two positive draft segments.

13. The method of claim 12, wherein extracting the first plurality of segments includes a specific sequence of removing the central cylindrical segment, removing the two positive draft segments, and removing the remaining segments.

14. The method of claim 12, wherein extracting each of the second plurality of segments and the first plurality of segments includes a specific extraction sequence.

15. The method of claim 12, forming the first and second layers further includes aligning a first alignment surface on a first periphery of the proximal surface of the first layer with a second alignment surface on a second periphery of the distal surface of the second layer.

16. The method of claim 15, wherein the first alignment surface is a chamfered recess and the second alignment surface is a corresponding protrusion.

17. The method of claim 12, wherein forming the first and second layers further includes each of the two positive draft segments having surfaces adjacent to a respective one of the central cylindrical segments and surfaces of a respective pair of the remaining segments.

18. The method of claim 17, wherein forming the first and second layers further includes chamfering proximal edges between the remaining segments.

19. The method of claim 17, wherein forming the first and second layers further includes providing grooves in a plurality of surfaces between respective segments of the first plurality of segments and/or the second plurality of segments to reduce a contact area therebetween.

20. A method of forming a layer of a multi-layer mandrel for a ceramic matrix composite (CMC) part, comprising:
forming a graphite core having a shape of the layer of the multi-layer mandrel;
cutting a circular shape in the graphite core transverse a plane of the layer to form a central cylindrical segment;
making two converging cuts substantially tangent to the circular shape to form a first positive draft segment;
making two converging cuts substantially tangent to the circular shape to form a second positive draft segment;
making a first cut substantially normal to the circular shape to form two remaining segments, at least one of which is a positive draft segment; and
making a second cut substantially normal to the circular shape to form an additional two remaining segments, at least one of which is a positive draft segment.
